(19) United States
(12) Patent Application Publication
(10) Pub. No.: US 2023/0369733 A1
(43) Pub. Date: Nov. 16, 2023

(54) LITHIUM-ION BATTERY

(71) Applicant: Zhuhai CosMX Battery Co., Ltd., Guangdong (CN)

(72) Inventors: Pan HAN, Guangdong (CN); Xiaobin LI, Guangdong (CN); Shuangzhu FANG, Guangdong (CN); Junyi LI, Guangdong (CN)

(21) Appl. No.: 18/225,640

(22) Filed: Jul. 24, 2023

Related U.S. Application Data
(63) Continuation of application No. PCT/CN2022/094535, filed on May 23, 2022.

(30) Foreign Application Priority Data
Jun. 9, 2021 (CN) 2021106461410

(51) Int. Cl. H01M 50/595; H01M 10/0525; H01M 4/13

(52) U.S. Cl. CPC H01M 50/595; H01M 10/0525; H01M 4/13

(57) ABSTRACT

A lithium-ion battery includes a positive electrode piece, a negative electrode piece, a separator arranged between the positive electrode piece and the negative electrode piece, and an electrolyte. The positive electrode piece includes a positive electrode current collector, a positive diaphragm and a positive electrode tab which are attached to a surface of the positive electrode current collector. The negative electrode piece includes a negative electrode current collector, a negative electrode diaphragm and a negative electrode tab which are attached to a surface of the negative electrode current collector. The negative electrode diaphragm is provided with a first groove in which the negative electrode tab is arranged. The positive electrode piece opposite to the first groove is provided with a first insulating adhesive tape thereon, and the positive electrode diaphragm around an edge of the first insulating adhesive tape is provided with a first adhesive tape groove.

### CROSS-REFERENCE TO RELATED APPLICATIONS

This application is a continuation of International Application No. PCT/CN2022/094535, filed on May 23, 2022, which claims priority to Chinese Patent Application No. 202110646141.0, filed on Jun. 9, 2021, entitled “LITHIUM-ION BATTERY” The disclosures of the aforementioned applications are hereby incorporated by reference in their entireties.

### TECHNICAL FIELD

The present application relates to the technical field of lithium-ion batteries, and in particular, to a lithium-ion battery.

### BACKGROUND

Lithium-ion battery is a new type of secondary battery that mainly relies on the movement of lithium ions between the positive and negative electrodes to operate. It has advantages of, for example, high energy density and power density, high working voltage, light weight, small volume, long cycle life, good safety, green and environmentally friendly, and has broad application prospects in portable appliances, electric tools, large-scale energy storage, electric transportation power supplies and so on.

The positive electrode tab and negative electrode tab of the lithium-ion battery in traditional wound structure are welded to a blank area at the head or tail of the current collector of corresponding electrode piece, and then positioned and wound with the tabs. The core is rolled up and assembled into a punched and specific sized aluminum-laminated film for packaging, baked out excess moisture, injected with a specific electrolyte, and left to stand for a certain period of time to allow the battery cell to be activated, evacuated, and capacity graded.

The existing lithium-ion battery in wound structure involves removing the active material by using a certain method at a specific position of the current collector that has been coated with the active material, and then welding the tab to the current collector with the active material removed, and then positioning and winding at the cut position of the electrode piece, and then performing a series of production processes such as packaging, baking, and liquid injection according to a normal process. Compared with the lithium-ion battery in traditional structure, the lithium-ion battery in existing structure can reduce the internal resistance of the lithium-ion battery, increase the charging speed, and reduce the temperature rise during charging and discharging.

The negative electrode tab of the lithium-ion battery in existing wound structure has no effective negative electrode active material, and cannot receive the lithium ions released from the positive electrode active material layer corresponding to the negative electrode tab. In order to solve this problem, the person skilled in the art usually uses an adhesive tape in positive electrode area corresponding to the negative electrode tab for isolation protection. However, in later stage of cycling or use of the battery, lithium precipitation will occur in the negative electrode area corresponding to the peripheral area of the position of the protective adhesive tape, which would affect the reliability of the electrical performance, especially the safety performance. How to solve the occurrence of lithium precipitation in the negative electrode area corresponding to the isolating protection of the adhesive tape of the lithium-ion battery in wound structure has become a technical problem to be solved by the person skilled in the art.

### SUMMARY

An object of the present application is to provide a lithium-ion battery in which a groove which is used for isolating an insulating adhesive tape from an active material is provided on a positive electrode piece, to avoid migration of excessive lithium ions deintercalated from a positive electrode active material layer around the insulating adhesive tape to a corresponding negative electrode area, thereby improving the electrical performance and safety performance of the lithium-ion battery.

In order to achieve the object of the present application, the following technical solution is adopted:

A lithium-ion battery, including a positive electrode piece, a negative electrode piece, a separator arranged between the positive electrode piece and the negative electrode piece, and an electrolyte, where the positive electrode piece includes a positive electrode current collector, a positive electrode diaphragm and a positive electrode tab which are attached to a surface of the positive electrode current collector, the negative electrode piece includes a negative electrode current collector, a negative electrode diaphragm and a negative electrode tab which are attached to a surface of the negative electrode current collector, and the negative electrode diaphragm is provided with a first groove, the negative electrode tab is arranged in the first groove, the positive electrode piece opposite to the first groove is provided with a first insulating adhesive tape thereon and the positive electrode diaphragm on the edge of the first insulating adhesive tape is provided with a first adhesive tape groove.

Further, the first groove is provided with a first tab adhesive tape; a projection of the first tab adhesive tape is covered by the first insulating adhesive tape in a thickness direction of the battery.

As a specific embodiment, the positive electrode diaphragm is arranged below the first insulating adhesive tape or the positive electrode current collector is arranged below the first insulating adhesive tape.

As a specific embodiment, the positive electrode diaphragm is arranged below the first insulating adhesive tape and the first adhesive tape groove is U-shaped, or the positive electrode current collector is located below the first insulating adhesive tape and the first adhesive tape groove is rectangular.

Further, the negative electrode piece is provided with a second groove in an area of the negative electrode diaphragm opposite to the first groove, and the positive electrode piece opposite to the second groove is provided with a second insulating adhesive tape, and the positive electrode diaphragm around an edge of the second insulating adhesive tape is provided with a second adhesive tape groove.

Further, the second groove is provided with a second tab adhesive tape; a projection of the second tab adhesive tape is covered by the second insulating adhesive tape in the thickness direction of the battery.

As a specific embodiment, the positive electrode diaphragm is arranged below the second insulating adhesive tape or the positive electrode current collector is arranged below the second insulating adhesive tape.

As a specific embodiment, the positive electrode diaphragm is arranged below the second insulating adhesive tape and the second adhesive tape groove is U-shaped, or the positive electrode current collector is arranged below the second insulating adhesive tape and the second adhesive tape groove is rectangular.

Further, the positive electrode diaphragm is provided with a third groove, the positive electrode tab is arranged in the third groove, and the third groove is provided with a third tab adhesive tape.

Further, the positive electrode piece is provided with a fourth groove in an area of the positive electrode diaphragm opposite to the third groove, and the fourth groove is provided with a fourth tab adhesive tape.

As a specific embodiment, a width of the negative electrode tab ranges from 4-6 mm, and a length of a welding end of the negative electrode tab ranges from 20-30 mm.

As a specific embodiment, a width of the first groove ranges from 6-10.5 mm, and a length of the first groove ranges from 21-36 mm.

As a specific embodiment, a width of the first tab adhesive tape ranges from 7-15 mm, and a length of the first tab adhesive tape ranges from 23-42 mm.

As a specific embodiment, a width of the first insulating adhesive tape ranges from 11-25 mm, and a length of the first insulating adhesive tape ranges from 25-48 mm.

As a specific embodiment, a maximum size between an edge of the first insulating adhesive tape and an edge of the first adhesive tape groove is greater than or equal to 0.5 mm.

As a specific embodiment, a width of the second insulating adhesive tape ranges from 11-25 mm, and a length of the second insulating adhesive tape ranges from 25-48 mm.

As a specific embodiment, a maximum size between an edge of the second insulating adhesive tape and an edge of the second adhesive tape groove is greater than or equal to 0.5 mm.

The beneficial effects of the present application:

The present application, by setting on the positive electrode piece the groove which is used for isolating the insulating adhesive tape from an active material, avoids the migration of excessive lithium ions deintercalated from the positive electrode active material layer around the insulating adhesive tape to the corresponding negative electrode area, thereby improving the electrical performance and safety performance of the lithium-ion battery. Specifically, by providing on the positive electrode piece the groove which is used for isolating the insulating adhesive tape from the active material, on the one hand, it is possible to prevent the delithiation of active material around the insulating adhesive tape; on the other hand, it is possible to isolate the conduction between the positive electrode active material at the bottom of the insulating adhesive tape from the positive electrode active material in other area, avoiding the complete deactivation and thus complete delithiation loss of the positive electrode active material at the bottom of the adhesive tape. Furthermore, the present application may avoid the problem of flatness deterioration caused by removing all the positive electrode active material at the bottom of the adhesive tape while reducing the risk of lithium precipitation in the corresponding negative electrode area. Furthermore, the influence of a special structure of the tab on the energy density of the battery cell is reduced by controlling the size of the insulating adhesive tape and the size of the groove.

### BRIEF DESCRIPTION OF DRAWINGS

In order to illustrate the embodiments of the present application more clearly, the drawings required in the embodiments will be briefly introduced below. The drawings in the following description are only embodiments of the present application. For the person skilled in the art, other drawings may be obtained based on these drawings without creative work.

FIG. 1 is a schematic diagram of front and back sides of a positive electrode current collector provided in the Embodiment 1 of the present application.

FIG. 2 is a schematic diagram of front and back sides of a positive electrode current collector provided in the Embodiment 2 of the present application (removing a front side active material within a groove which is used for isolating an insulating adhesive tape from the active material in the front side and a back side active material within a groove which is used for isolating the insulating adhesive tape from the active material in the back side).

### DESCRIPTION OF EMBODIMENTS

In order to make the technical problems to be solved, technical solutions, and beneficial effects by the present application clearer, the present application is further explained in detail in combination with the drawings and embodiments. It should be understood that the specific embodiments described here are only used to explain the present application, but not intend to limit the present application. In the description of the present application, it should be understood that the orientation or positional relationships indicated by the terms “length”, “width”, “thickness”, etc. are based on the orientation or positional relationships shown in the drawings, and are only for the convenience of describing the present application and simplifying the description, rather than indicating or implying that the device or element referred to must have a specific orientation, be constructed and operated in a specific orientation, and therefore they cannot be understood as a limitation of the present application.

For the convenience of description, the present application defines a shorter edge of the positive electrode piece as a width direction of the electrode piece, and an extension direction of the electrode piece perpendicular to the width direction is defined as a length direction of the electrode piece. It is easy to understand that since the winding of the electrode piece is carried out along the length direction, in the final wound battery cell, the width direction of the electrode piece corresponds to the length direction of the battery cell, that is, the width direction of the electrode piece is not the same as the width direction of the battery cell, but the width directions of them are perpendicular to each other.

### Embodiment 1

A lithium-ion battery includes a lithium-ion battery cell, an electrolyte (not shown), and a packaging shell (not shown). The packaging shell (in this embodiment, an aluminum-laminated film) is used to encapsulate the battery cell, and the moisture in the battery cell is removed by baking under a vacuum condition, and then the electrolyte is injected, and the battery is formed and sorted to obtain the lithium-ion battery; wherein, the lithium-ion battery cell includes a positive electrode piece, a negative electrode piece (not shown) and a separator (not shown), where the positive electrode piece, the separator and the negative electrode piece are stacked in sequence and then wound.

In the present embodiment, the negative electrode piece includes a negative electrode current collector, a negative electrode diaphragm and a negative electrode tab which are attached to a surface of the negative electrode current collector, where the negative electrode diaphragm is provided with a first groove; the negative electrode tab is provided in the first groove, and a first tab adhesive tape is provided on the first groove; the negative electrode piece is provided with a second groove in the negative electrode diaphragm area opposite to the first groove, and the second groove is provided with a second tab adhesive tape; the negative electrode piece includes a negative electrode current collector shown in a rectangular sheet structure, and as a specific embodiment, the negative electrode current collector uses a copper foil.

In the present embodiment, the positive electrode piece includes a positive electrode current collector, a positive electrode diaphragm and a positive electrode tab 300 which are attached to a surface of the positive electrode current collector; the positive electrode current collector front side (side A) 100 arranged on the front side of the negative electrode piece includes a front side positive electrode active area 110 and a front side positive electrode blank area 120, and the front side positive electrode active area 110 is arranged at the head and middle of the positive electrode current collector front side 100, and the front side positive electrode blank area 120 is arranged at the tail of the positive electrode current collector front side 100; the front side positive electrode active area 110 is attached with the positive electrode diaphragm, and the front side positive electrode blank area 120 is a blank positive electrode current collector (that is, no positive electrode diaphragm is attached to the front side positive electrode blank area 120); the front side positive electrode active area 110 is provided with a third groove, a first insulating adhesive tape 130 and a first tail insulating adhesive tape 140 arranged at the tail of the front side positive electrode active area 110 in sequence along the direction of positive electrode piece from head to tail; in the thickness direction of the battery, a projection of the first tab adhesive tape is covered by the first insulating adhesive tape 130; the positive electrode tab 300 is provided in the third groove; the first insulating adhesive tape 130 is opposite to the first groove on the negative electrode piece, and a first adhesive tape groove 112 is arranged on the positive electrode diaphragm at the edge of the first insulating adhesive tape 130; as a specific embodiment, the positive electrode current collector is in a rectangular sheet structure, and the positive electrode current collector uses an aluminum foil.

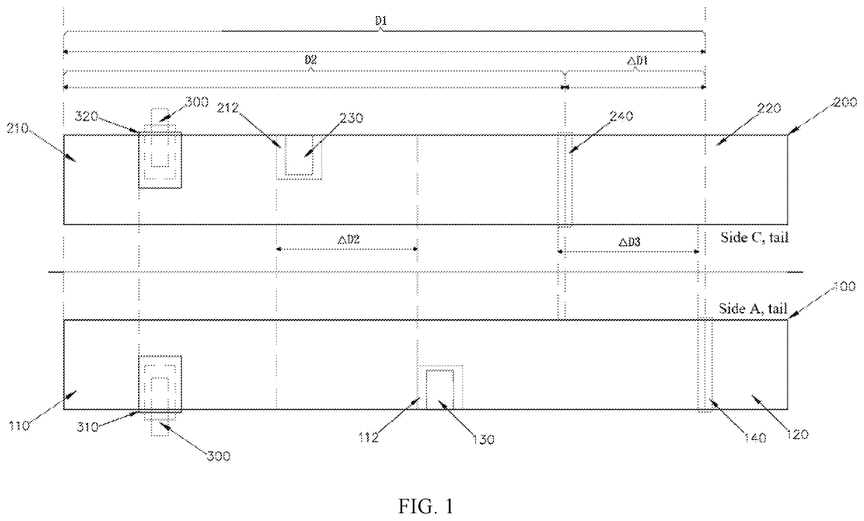

As shown in FIG. 1, the positive electrode current collector back side (side C) 200 arranged on the back side of the negative electrode piece includes a back side positive electrode active area 210 and a back side positive electrode blank area 220, and the back side positive electrode active area 210 is arranged at the head and middle of the positive electrode current collector back side 200, and the back side positive electrode blank area 220 is arranged at the tail of the positive electrode current collector back side 200; the back side positive electrode active area 210 is attached with the positive electrode diaphragm, and the back side positive electrode blank area 220 is a blank positive electrode current collector (that is, no positive electrode diaphragm is attached to the back side positive electrode blank area 220); the back side positive electrode active area 210 is provided with a fourth groove, a second insulating adhesive tape 230, and a second tail insulating adhesive tape 240 arranged at the tail of the back side positive electrode active area 210 in sequence along the direction of positive electrode piece from head to tail; in the thickness direction of the battery, a projection of the second tab adhesive tape is covered by the second insulating adhesive tape 230; the second insulating adhesive tape 230 is opposite to the second groove on the negative electrode piece, and a second adhesive tape groove 212 is arranged on the positive electrode diaphragm at the edge of the second insulating adhesive tape 230.

In the present embodiment, a size of a gap between the edge of the first insulating adhesive tape 130 and the edge of the first adhesive tape groove is greater than or equal to 0.5 mm; a size of a gap between the edge of the second insulating adhesive tape 230 and the edge of the second adhesive tape groove is greater than or equal to 0.5 mm; the positive electrode diaphragm is arranged below the first insulating adhesive tape 130 and the second insulating adhesive tape 230.

In the present embodiment, the third groove on the positive electrode current collector front side 100 is rectangular, and the positive electrode active material is removed from a rectangular area in which the third groove is located (that is, at the bottom of the rectangular area corresponding to the third groove is the positive electrode current collector, and at the side thereof is the positive electrode active material); the positive electrode tab 300 may be arranged in the third groove and connected to the positive electrode current collector at the bottom of the third groove by welding; the third groove welded with the positive electrode tab 300 is covered with a third tab adhesive tape 310 for protecting the positive electrode tab 300; the first adhesive tape groove 112 is U-shaped, and the positive electrode active material is removed from a U-shaped area in which the first adhesive tape groove 112 is located (that is, at the bottom of the U-shaped area corresponding to the first adhesive tape groove 112 is the positive electrode current collector, and at the side thereof is the positive electrode active material), and an area inside the first adhesive tape groove 112 where the positive electrode active material is not removed (the area within the first insulating adhesive tape 130 as shown in FIG. 1) is covered with the first insulating adhesive tape 130, and a size of the first insulating adhesive tape 130 is larger than a size of the area inside the first adhesive tape groove 112 where the positive electrode active material is not removed.

In the present embodiment, the fourth groove on the positive electrode current collector back side 200 is rectangular, and the positive electrode active material is removed from the rectangular area in which the fourth groove is located (that is, at the bottom of a rectangular area corresponding to the fourth groove is the positive electrode current collector, and at the side thereof is the positive electrode active material); the positive electrode tab 300 may be arranged in the fourth groove and connected to the positive electrode current collector at the bottom of the fourth groove by welding; the fourth groove welded with the positive electrode tab 300 is covered with a fourth tab adhesive tape 320 for protecting the positive electrode tab 300; the second adhesive tape groove 212 is U-shaped, and the positive electrode active material is removed from the U-shaped area corresponding to the second adhesive tape groove 212 (that is, at the bottom of the U-shaped area corresponding to the second adhesive tape groove 212 is the positive electrode current collector, and at the side thereof is the positive electrode active material), and an area inside the U-shaped area corresponding to the second adhesive tape groove 212 where the positive electrode active material is not removed (the area inside the second insulating adhesive tape 230 as shown in FIG. 1) is covered with the second insulating adhesive tape 230.

In the present embodiment, a width of the negative electrode tab is in the range of 4-6 mm, a length of the negative electrode tab is in the range of 34-50 mm, and a length of a welding end of the negative electrode tab is in the range of 20-30 mm; a width of the first groove for providing the negative electrode tab is in the range of 6-10.5 mm (2-5 mm wider than the width of the tab), and a length of the first groove is in the range of 21-36 mm (1-6 mm longer than the length of the welding end of the tab): the first groove larger in size than the negative electrode tab is to ensure that the tab will not be welded to the active material when fluctuating (i.e., change in welding position of the tab) in processing procedure.

In the present embodiment, a width of the first tab adhesive tape is in the range of 7-15 mm (1-4 mm wider than the width of the first groove), and a length of the first tab adhesive tape is in the range of 23-42 mm (2-6 mm longer than the length of the first groove): the first tab adhesive tape larger in size than the first groove is to ensure that the adhesive tape may completely cover a position to be cleaned to prevent lithium ions from precipitation from the position to be cleaned.

In the present embodiment, a width of the first insulating adhesive tape 130 is in the range of 11-25 mm (4-10 mm wider than the width of the first tab adhesive tape), a width of the second insulating adhesive tape 230 is in the range of 11-25 mm (4-10 mm wider than the width of the second tab adhesive tape), a length of the first insulation adhesive tape 130 is in the range of 25-48 mm (2-6 mm longer than the length of the first tab adhesive tape), and a length of the second insulation adhesive tape 230 is in the range of 25-48 mm (2-6 mm longer than the length of the second tab adhesive tape): both the first insulation adhesive tape 130 and the second insulation adhesive tape 230 larger in size than the first tab adhesive tape is to ensure that no positive electrode active material comes out from an area of the negative electrode with no active material, and meanwhile to ensure that the negative electrode active material is able to cover the positive electrode active material.

In the present embodiment, a maximum size between the edge of the first insulating adhesive tape 130 and the edge of the first adhesive tape groove 112 is greater than or equal to 0.5 mm, and a maximum size between the edge of the second insulating adhesive tape 230 and the edge of the second adhesive tape groove 212 is greater than or equal to 0.5 mm. The adhesive tape groove larger in size than the insulating adhesive tape is to remove the positive electrode active material around the insulating adhesive tape.

In the present embodiment, taking the head of the positive electrode piece as a reference point, the third groove on the positive electrode current collector front side 100 is arranged opposite to the fourth groove on the positive electrode current collector back side 200; a length D1 of the front side positive electrode active area 110 located on the positive electrode current collector front side 100 is longer than a length D2 of the back side positive electrode active area 210 located on the positive electrode current collector back side 200 (that is, a length of the positive electrode current collector front side 100 coated with the positive electrode diaphragm is longer than a length of the positive electrode current collector back side 200 coated with the back side active material), wherein a length difference ΔD1 between the front side positive electrode active area 110 and the back side positive electrode active area 210 is ΔD1=D1−D2 (width of battery cell−thickness of battery cell/2)×2; a distance difference ΔD2 between the first adhesive tape groove 112 located on the positive electrode current collector front side 100 and the second adhesive tape groove 212 located on the positive electrode current collector back side 200 approximately equals to the length difference ΔD1 between the front side positive electrode active area 110 and the back side positive electrode active area 210, that is, ΔD2≈ΔD1; a position difference ΔD3 between the first tail insulating adhesive tape 140 located on the positive electrode current collector front side 100 and the second tail insulating adhesive tape 240 located on the positive electrode current collector back side 200 approximately equals to the length difference ΔD1 between the front side positive electrode active area 110 and the back side positive electrode active area 210, that is, ΔD3≈ΔD1.

In the present embodiment, the active material around the edge of the first insulating adhesive tape 130 is removed by setting the first insulating adhesive tape 130 inside the first adhesive tape groove 112, preventing the active material around the first insulating adhesive tape 130 from delithiation; on the other hand, the positive electrode diaphragm (i.e., the positive electrode diaphragm between the first insulating adhesive tape 130 and the positive electrode current collector) located at the bottom of the first insulating adhesive tape 130 is separated from the positive electrode diaphragm located in other area of the front side positive electrode active area 110 by the first adhesive tape groove 112, to make the positive electrode diaphragm at the bottom of the first insulating adhesive tape 130 completely inactivated, reducing the probability of delithiation, and thus reducing the risk of lithium precipitation in a corresponding peripheral area of the negative electrode tab; at the same time, compared with removing the positive electrode diaphragm at the bottom of the first insulating adhesive tape 130, in the present embodiment, only the positive electrode diaphragm around the first insulating adhesive tape 130 is removed, which reduces the probability of deterioration of flatness of the positive electrode current collector front side 100.

In the present embodiment, a gap size of the first adhesive tape groove 112 (that is, a maximum size between an outer edge of the first insulating adhesive tape 130 and an outer edge of the first adhesive tape groove 112) is greater than or equal to 0.5 mm; positions of the third groove located on the positive electrode current collector front side 100, the first adhesive tape groove 112, the first insulating adhesive tape 130 and the first tail insulating adhesive tape 140 and positions of the fourth groove located on the positive electrode current collector back side 200, the second adhesive tape groove 212, the second insulating adhesive tape 230 and the second tail insulating adhesive tape 240 are related to the length, height and thickness of the lithium-ion battery cell and a position of the tab to an edge of the current collector, and may be specifically determined according to an actual situation.

In the present embodiment, the first insulating adhesive tape 130 includes one layer of insulating adhesive tape.

In other embodiments, the first insulating adhesive tape 130 includes multiple layers (more than two layers) of insulating adhesive tape, wherein the size of the insulating adhesive tape closer to the bottom of the first adhesive tape groove 112 is smaller, and the size of the insulating adhesive tape closest to the bottom of the first adhesive tape groove 112 is larger than the size of the area inside the first adhesive tape groove 112 where the positive electrode active material is not removed; the second insulating adhesive tape 230 includes multiple layers of insulating adhesive tape, wherein the size of the insulating adhesive tape closer to the second adhesive tape groove 212 is smaller, and the size of the insulating adhesive tape closest to the bottom of the second adhesive tape groove 212 is larger than the size of the area inside the second adhesive tape groove 212 where the positive electrode active material is not removed.

As a specific embodiment, the positive electrode diaphragm includes a positive electrode active material layer material, a conductive agent and a binder, and the positive electrode active material layer material includes one of nickel cobalt manganese ternary material, lithium iron phosphate material, lithium cobaltate material, lithium manganate material, lithium nickelate material, lithium-rich manganese based material, activated carbon, etc., or a combination thereof, which are well-known to a person skilled in the art, and therefore would not be further elaborated; the conductive agent may be one or more of conductive carbon black, carbon nanotube, conductive graphite and graphene, and the binder may be one or more of polyvinylidene fluoride, vinylidene fluoride-fluorinated olefin copolymer, polytetrafluoroethylene, sodium carboxymethyl cellulose, styrene butadiene rubber, polyurethane, fluorinated rubber and polyvinyl alcohol, and a content (mass percentage) of the positive electrode active material layer material in the positive electrode active material layer is 96-98.5%, and a content of the conductive agent is 0.5-2.5%, and a content of the binder is 1-1.5%.

### Embodiment 2

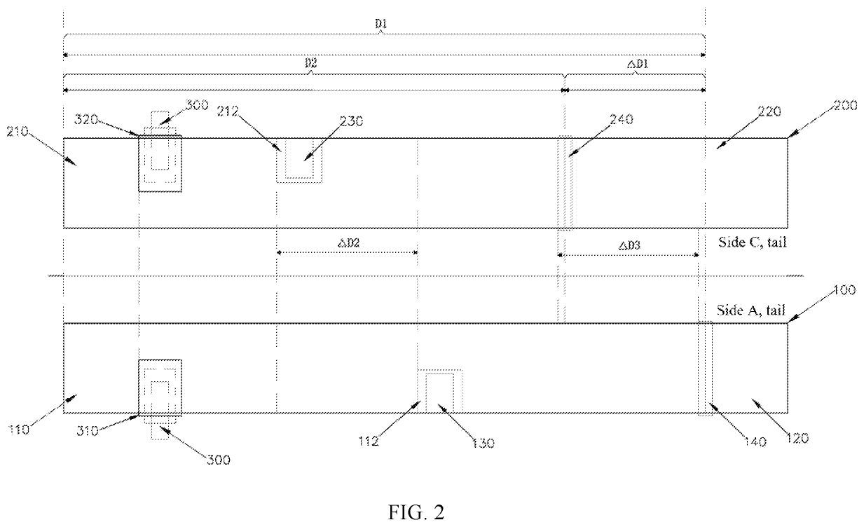

As shown in FIG. 2, a difference between the present embodiment and Embodiment 1 lies in that: the positive electrode diaphragm is removed below the first insulating adhesive tape 130 and the second insulating adhesive tape 230; the first adhesive tape groove 112 is rectangular, i.e., a case where the positive electrode diaphragm is removed from the rectangular area corresponding to the first adhesive tape groove 112 (that is, at the bottom of the first adhesive tape groove 112 is the positive electrode current collector, and at the side thereof is the positive electrode active material); the second adhesive tape groove 212 is rectangular, i.e., a case where the positive electrode active material is removed from the rectangular area corresponding to the second adhesive tape groove 212 (that is, at the bottom of the second adhesive tape groove 212 is the positive electrode current collector and at the side thereof is the positive electrode active material).

In the present embodiment, an interior of the first adhesive tape groove 112 is covered with the first insulating adhesive tape 130, and a size of the first insulating adhesive tape 130 is smaller than a size of the first adhesive tape groove 112, so that the first insulating adhesive tape 130 is spaced a certain distance from the positive electrode diaphragm of the positive electrode current collector front side 100, a specific spacing being determined by a size difference between the first adhesive tape groove 112 and the first insulating adhesive tape 130 as well as the positioning of the first insulating adhesive tape 130 inside the first adhesive tape groove 112.

In the present embodiment, an interior of the second adhesive tape groove 212 is covered with the second insulating adhesive tape 230, and a size of the second insulating adhesive tape 230 is smaller than a size of the second adhesive tape groove 212, so that the second insulating adhesive tape 230 is spaced a certain distance from the back side positive electrode active material layer of the positive electrode current collector back side 200, a specific spacing being determined by a size difference between the second adhesive tape groove 212 and the second insulating adhesive tape 230 as well as the positioning of the second insulating adhesive tape 230 inside the second adhesive tape groove 212.

In the present embodiment, the positive electrode diaphragm at the bottom of and around the first insulating adhesive tape 130 is removed by arranging the first insulating adhesive tape 130 inside the first adhesive tape groove 112, preventing the active material at the bottom of and around the first insulating adhesive tape 130 from delithiation.

The above are only the preferred embodiments of the present application, and the protection scope of the present application is not limited to the above embodiments. All technical solutions under the idea of the present application are within the protection scope of the present application. It should be pointed out that for the person skilled in the art, at least one improvement and modification without departing from the principle of the present application, these improvements and modifications should also be regarded as the protection scope of the present application.

What is claimed is:

1. A lithium-ion battery, comprising a positive electrode piece, a negative electrode piece, a separator arranged between the positive electrode piece and the negative electrode piece, and an electrolyte, the positive electrode piece comprising a positive electrode current collector, a positive electrode diaphragm and a positive electrode tab which are attached to a surface of the positive electrode current collector, and the negative electrode piece comprising a negative electrode current collector, a negative diaphragm and a negative electrode tab which are attached to a surface of the negative electrode current collector, wherein the negative diaphragm is provided with a first groove, and the negative electrode tab is arranged in the first groove, the positive electrode piece opposite to the first groove is provided with a first insulating adhesive tape thereon and the positive electrode diaphragm on an edge of the first insulating adhesive tape is provided with a first adhesive tape groove.

2. The lithium-ion battery according to claim 1, wherein a first tab adhesive tape is arranged on the first groove; and in a thickness direction of the battery, a projection of the first tab adhesive tape is covered by the first insulating adhesive tape.

3. The lithium-ion battery according to claim 1, wherein the positive electrode diaphragm is provided below the first insulating adhesive tape or the positive electrode current collector is provided below the first insulating adhesive tape.

4. The lithium-ion battery according to claim 3, wherein the positive electrode diaphragm is provided below the first insulating adhesive tape, the first adhesive tape groove is U-shaped or the positive electrode current collector is provided below the first insulating adhesive tape, and the first adhesive tape groove is rectangular.

5. The lithium-ion battery according to claim 1, wherein a second groove is provided in a negative electrode diaphragm area of the negative electrode piece opposite to the first groove, and the positive electrode piece opposite to the second groove is provided with a second insulating adhesive tape, the positive electrode diaphragm around an edge of the second insulating adhesive tape is provided with a second adhesive tape groove.

6. The lithium-ion battery according to claim 5, wherein a second tab adhesive tape is arranged on the second groove; and in a thickness direction of the battery, a projection of the second tab adhesive tape is covered by the second insulating adhesive tape.

7. The lithium-ion battery according to claim 5, wherein the positive electrode diaphragm is provided below the second insulating adhesive tape or the positive electrode current collector is provided below the second insulating adhesive tape.

8. The lithium-ion battery according to claim 7, wherein the positive electrode diaphragm is provided below the second insulating adhesive tape, the second adhesive tape groove is U-shaped or the positive electrode current collector is provided below the second insulating adhesive tape, and the second adhesive tape groove is rectangular.

9. The lithium-ion battery according to claim 1, wherein the positive electrode diaphragm is provided with a third groove, and the positive electrode tab is provided in the third groove, and a third tab adhesive tape is provided on the third groove.

10. The lithium-ion battery according to claim 9, wherein a fourth groove is provided in a positive electrode diaphragm area of the positive electrode piece opposite to the third groove, and a fourth tab adhesive tape is provided on the fourth groove.

11. The lithium-ion battery according to claim 1, wherein a width of the negative electrode tab is in a range of 4-6 mm, and a length of a welding end of the negative electrode tab is in a range of 20-30 mm.

12. The lithium-ion battery according to claim 1, wherein a width of the first groove is in a range of 6-10.5 mm, and a length of the first groove is in a range of 21-36 mm.

13. The lithium-ion battery according to claim 2, wherein a width of the first tab adhesive tape is in a range of 7-15 mm, and a length of the first tab adhesive tape is 23-42 mm.

14. The lithium-ion battery according to claim 1, wherein a width of the first insulating adhesive tape is in a range of 11-25 mm, and a length of the first insulating adhesive tape is in a range of 25-48 mm.

15. The lithium-ion battery according to claim 1, wherein a maximum size between the edge of the first insulating adhesive tape and an edge of the first adhesive tape groove is greater than or equal to 0.5 mm.

16. The lithium-ion battery according to claim 5, wherein a width of the second insulating adhesive tape is in a range of 11-25 mm, and a length of the second insulating adhesive tape is in a range of 25-48 mm.

17. The lithium-ion battery according to claim 5, wherein a maximum size between the edge of the second insulating adhesive tape and an edge of the second adhesive tape groove is greater than or equal to 0.5 mm.
